(19) United States
(12) Patent Application Publication
(10) Pub. No.: US 2011/0300465 A1
(43) Pub. Date: Dec. 8, 2011

(54) FUEL CELL STACK

(75) Inventors: Hiroaki OHTA, Wako (JP); Yasunori KOTANI, Wako (JP); Chikara IWASAWA, Wako (JP); Masahiro MOHRI, Wako (JP)

(73) Assignee: HONDA MOTOR CO., LTD., Tokyo (JP)

(21) Appl. No.: 13/115,045

(22) Filed: May 24, 2011

(30) Foreign Application Priority Data
Jun. 7, 2010 (JP) 2010-129595

(51) Int. Cl. H01M 8/04; H01M 8/24

(52) U.S. Cl. 429/457

(57) ABSTRACT

A fuel cell stack includes power generation devices each including membrane electrode assemblies and corrugated separators. A coolant channel is provided between the power generation devices. A first-end corrugated separator has a first protrusion that protrudes between recesses of the coolant channel in a direction away from one of adjacent membrane electrode assemblies of the membrane electrode assemblies. The first-end corrugated separator is disposed at a first end of each of the power generation devices in a stacking direction. A second-end corrugated separator has a second protrusion that protrudes between recesses of the coolant channel in a direction away from another of the adjacent membrane electrode assemblies. The second-end corrugated separator is disposed at a second end of each of the power generation devices in the stacking direction. The first protrusion and the second protrusion are disposed to be superposed with each other in the stacking direction.

### CROSS-REFERENCE TO RELATED APPLICATIONS

The present application claims priority under 35 U.S.C. §119 to Japanese Patent Application No. 2010-129595, filed Jun. 7, 2010, entitled “Fuel Cell Stack.” The contents of this application are incorporated herein by reference in their entirety.

### BACKGROUND OF THE INVENTION

1. Field of the Invention

The present invention relates to a fuel cell stack.

2. Description of the Related Art

A solid-polymer fuel cell, for example, includes unit cells. Each of the unit cells includes a membrane electrode assembly (MEA) and a pair of separators sandwiching the MEA therebetween. The MEA includes an electrolyte membrane, which is a polymer ion-exchange membrane, and an anode electrode and a cathode electrode sandwiching the electrolyte membrane therebetween. This type of fuel cell is used as a fuel cell stack, which usually includes a certain number of such unit cells.

In the above-described fuel cell, a fuel gas channel for supplying a fuel gas to the anode electrode is formed on a surface of one of the separators, and an oxidant gas channel for supplying an oxidant gas to the cathode electrode is formed on a surface of the other of the separators. Moreover, a coolant channel, through which coolant flows, extends between and along surfaces of the separators that are disposed adjacent to each other in each unit cell or in a plurality of the unit cells.

If metal separators are used as the separators and when recesses for a fuel gas channel are formed on one surface of an anode-side metal separator, protrusions having a shape corresponding to the recesses are formed on the back surface of the anode-side metal separator. Moreover, when recesses for an oxidant gas channel are formed on one surface of a cathode-side metal separator, protrusions having a shape corresponding to the recesses are formed on the back surface of the cathode-side metal separator.

FIG. 5 illustrates a fuel cell stack described in Japanese Unexamined Patent Application Publication No. 2000-208153. In this fuel cell stack, first power generation units 1a and second power generation units 1b are stacked alternately, and end plates 2a and 2b are disposed at ends in the stacking direction.

Each of the first power generation units 1a includes a first metal separator 3a, a first MEA 4a, a second metal separator 3b, a second MEA 4b, and a third metal separator 3c. Each of the second power generation units 1b includes a fourth metal separator 3d, a third MEA 4c, a fifth metal separator 3e, a fourth MEA 4d, and a sixth metal separator 3f.

Oxidant gas channels 5 are formed between the first metal separator 3a and the first MEA 4a, between the second metal separator 3b and the second MEA 4b, between the fourth metal separator 3d and the third MEA 4c, and between the fifth metal separator 3e and the fourth MEA 4d.

Fuel gas channels 6 are formed between the second metal separator 3b and the first MEA 4a, between the third metal separator 3c and the second MEA 4b, between the fifth metal separator 3e and the third MEA 4c, and between the sixth metal separator 3f and the fourth MEA 4d.

A cooling water channel 7 is formed between the third metal separator 3c of the first power generation unit 1a and the fourth metal separator 3d of the second power generation unit 1b. That is, the fuel cell stack has a so-called skip cooling structure having one cooling water channel for a certain number of unit cells.

### SUMMARY OF THE INVENTION

According to one aspect of the present invention, a fuel cell stack includes a plurality of power generation devices and a coolant channel. The plurality of power generation devices each include n membrane electrode assemblies, (n+1) corrugated separators, and a reactant gas channel. n is an even number. The membrane electrode assemblies each include electrodes and an electrolyte that is sandwiched between the electrodes. The corrugated separators are alternately stacked together with the membrane electrode assemblies. The corrugated separators sandwich both sides of the membrane electrode assemblies with third protrusions of the corrugated separators in a stacking direction. The reactant gas channel allows a reactant gas to flow along an electrode surface in a plane direction of the corrugated separators. The reactant gas is one of a fuel gas and an oxidant gas. The coolant channel is provided between the power generation devices. A first-end corrugated separator among the corrugated separators has a first protrusion that protrudes between recesses of the coolant channel in a direction away from one of adjacent membrane electrode assemblies of the membrane electrode assemblies. The first-end corrugated separator is disposed at a first end of each of the power generation devices in the stacking direction. A second-end corrugated separator among the corrugated separators has a second protrusion that protrudes between recesses of the coolant channel in a direction away from another of the adjacent membrane electrode assemblies. The second-end corrugated separator is disposed at a second end of each of the power generation devices in the stacking direction. The first protrusion and the second protrusion are disposed so as to be superposed with each other in the stacking direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of a fuel cell stack according to an embodiment of the present invention;

FIG. 2 is an exploded perspective view of a power generation unit of the fuel cell stack;

FIG. 3 is a sectional view of the fuel cell stack taken along line III-III of FIG. 2;

FIG. 4 is a partial sectional view of the fuel cell stack; and

FIG. 5 illustrates an existing fuel cell stack.

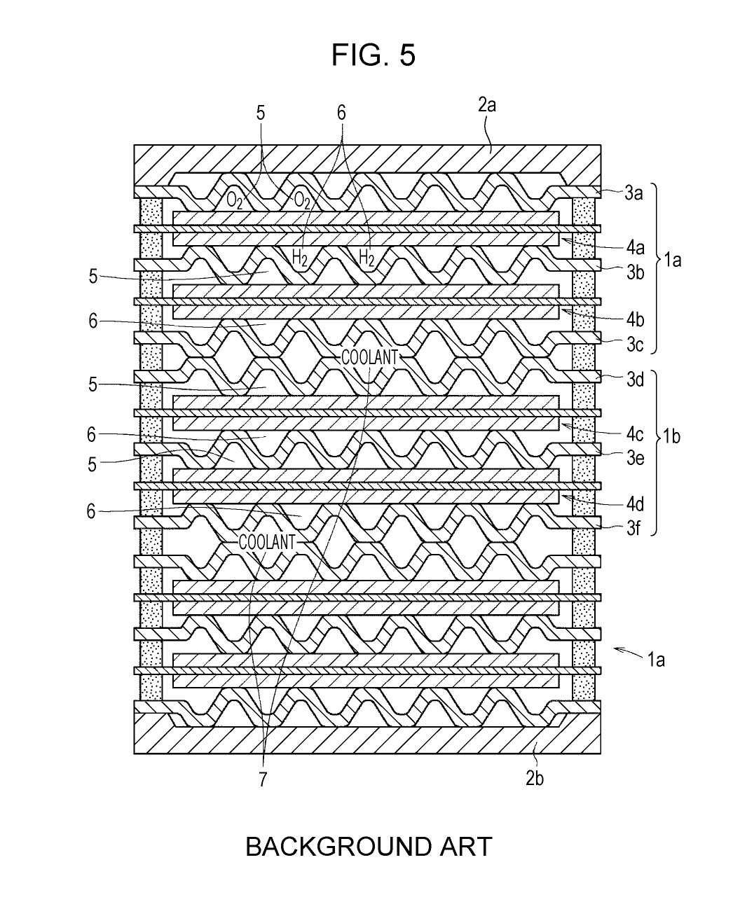

### DESCRIPTION OF THE EMBODIMENTS

The embodiments will now be described with reference to the accompanying drawings, wherein like reference numerals designate corresponding or identical elements throughout the various drawings.

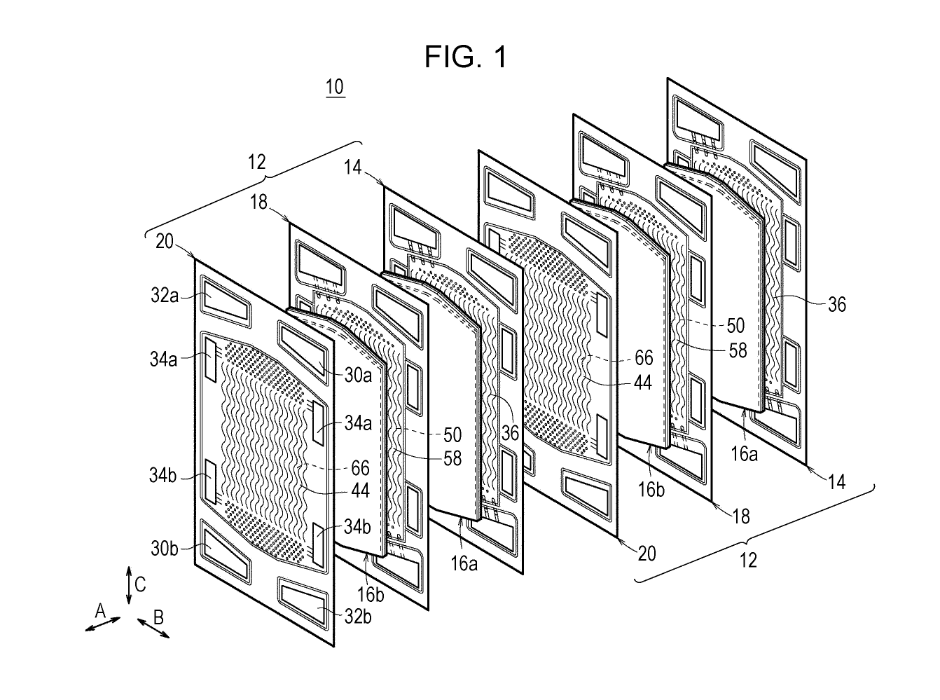

As illustrated in FIG. 1, a fuel cell stack 10 according to an embodiment of the present invention includes a plurality of power generation units 12. The power generation units 12 are stacked in a horizontal direction (direction of arrow A) or in the vertical direction (direction of arrow C) so as to form, for example, a fuel cell stack for a vehicle.

As illustrated in FIGS. 1 to 3, each of the power generation units 12 includes a first metal separator (corrugated separator) 14, a first membrane electrode assembly (MEA) 16a, a second metal separator (corrugated separator) 18, a second membrane electrode assembly (MEA) 16b, and a third metal separator (corrugated separator) 20. Each of the power generation units 12 may include n MEAS (where n is an even number equal to or larger than four) and (n+1) metal separators (where n+1 is an odd number equal to or larger than five). The MEAs and the metal separators are stacked alternately.

Each of the first, second, and third metal separators 14, 18 and 20 is made of, for example, a metal plate such as a steel plate, a stainless steel plate, an aluminum plate, a galvanized steel plate, or any of such metal plates coated with an anti-corrosive coating. Each of the first, second, and third metal separators 14, 18 and 20 has recesses and protrusions in sectional view, which are formed by press-molding a thin metal plate in a wave-like shape.

Instead of the first, second, and third metal separators 14, 18 and 20, for example, three types of corrugated carbon separators (corrugated separators) may be used. In this case, each of the corrugated carbon separators has recesses and protrusions in sectional view.

The surface area of the first membrane electrode assembly 16a is set to be smaller than that of the second membrane electrode assembly 16b. Each of the first and second membrane electrode assemblies 16a and 16b includes a solid-polymer electrolyte membrane 22, and an anode electrode 24 and a cathode electrode 26 that sandwich the solid-polymer electrolyte membrane 22 therebetween. The solid-polymer electrolyte membrane 22 is, for example, a thin film made of a perfluorosulfonate polymer that is impregnated with water. Each of the first and second membrane electrode assemblies 16a and 16b is a so-called stepped MEA in that the surface area of the anode electrode 24 is smaller than those of the solid-polymer electrolyte membrane 22 and the cathode electrode 26.

Each of the anode electrode 24 and the cathode electrode 26 includes a gas diffusion layer (not shown) and an electrode catalyst layer (not shown). The gas diffusion layer is made of carbon paper or the like. The electrode catalyst layer is made by uniformly coating a surface of the gas diffusion layer with porous carbon particles whose surfaces support a platinum alloy. The electrode catalyst layer is disposed on either side of the solid-polymer electrolyte membrane 22.

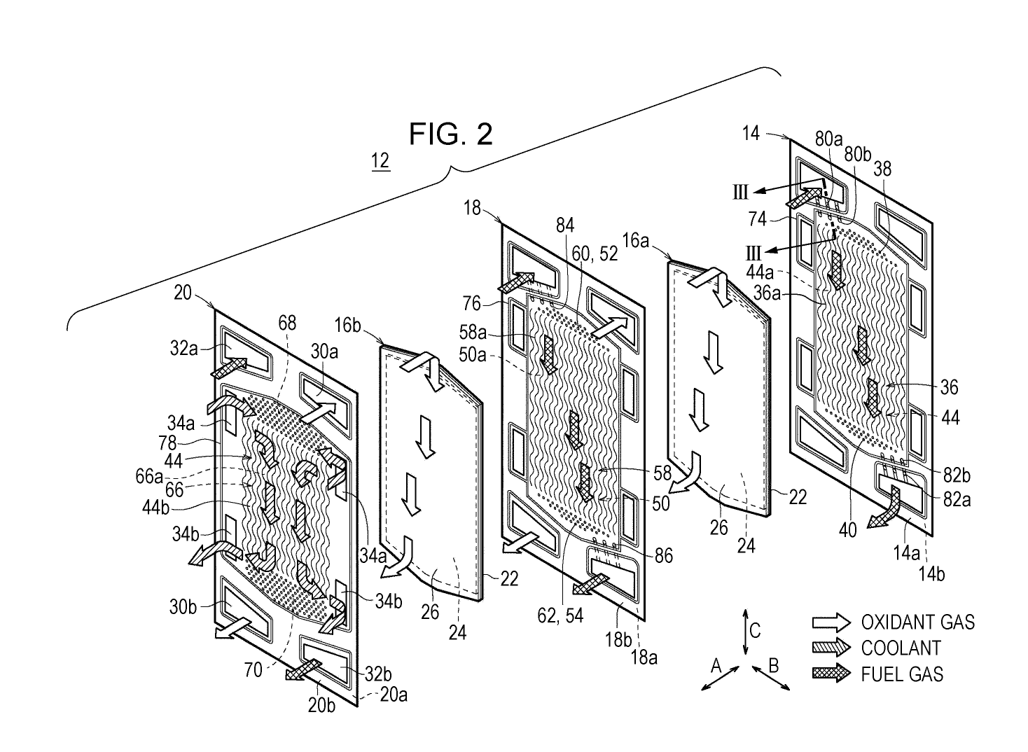

As illustrated in FIG. 2, an oxidant gas inlet manifold 30a and a fuel gas inlet manifold 32a are disposed in an upper end portion of the power generation unit 12 in the longitudinal direction (direction of arrow C). The oxidant gas inlet manifold 30a and the fuel gas inlet manifold 32a extend through the power generation unit 12 in the direction of arrow A. An oxidant gas, such as an oxygen-containing gas, is supplied through the oxidant gas inlet manifold 30a. A fuel gas, such as a hydrogen-containing gas, is supplied through the fuel gas inlet manifold 32a.

A fuel gas outlet manifold 32b and an oxidant gas outlet manifold 30b are disposed in a lower end portion of the power generation unit 12 in the longitudinal direction (direction of arrow C). The fuel gas outlet manifold 32b and the oxidant gas outlet manifold 30b extend through the power generation unit 12 in the direction of arrow A. The fuel gas is discharged through the fuel gas outlet manifold 32b. The oxidant gas is discharged through the oxidant gas outlet manifold 30b.

At least a pair of coolant inlet manifolds 34a are disposed in upper end portions of the power generation unit 12 in the lateral direction (direction of arrow B). The coolant inlet manifolds 34a extend through the power generation unit 12 in the direction of arrow A. A coolant is supplied through the coolant inlet manifolds 34a. At least a pair of coolant outlet manifolds 34b are disposed in lower end portions of the power generation unit 12 in the lateral direction. The coolant is discharged through the coolant outlet manifolds 34b.

One of the coolant inlet manifolds 34a is disposed near the oxidant gas inlet manifold 30a on one side of the power generation unit 12 in the direction of arrow B and the other of the coolant inlet manifolds 34a is disposed near the fuel gas inlet manifold 32a on the other side of the power generation unit 12 in the direction of arrow B. One of the coolant outlet manifolds 34b is disposed near the oxidant gas outlet manifold 30b on one side of the power generation unit 12 in the direction of arrow B and the other of the coolant outlet manifolds 34b is disposed near the fuel gas outlet manifold 32b on the other side of the power generation unit 12 in the direction of arrow B. There may be three or more coolant inlet manifolds 34a and three or more coolant outlet manifolds 34b.

A first fuel gas channel 36 is formed on a surface 14a of the first metal separator 14 that faces the first membrane electrode assembly 16a. The first fuel gas channel 36 connects the fuel gas inlet manifold 32a to the fuel gas outlet manifold 32b. The first fuel gas channel 36 includes a plurality of wave-shaped channel grooves (recesses) 36a that extend in the direction of arrow C. An inlet buffer portion 38 and an outlet buffer portion 40, each having embossed protrusions, are respectively disposed near the inlet and the outlet of the first fuel gas channel 36.

A part of a coolant channel 44 is formed on a surface 14b of the first metal separator 14. The coolant channel 44 connects the coolant inlet manifolds 34a to the coolant outlet manifolds 34b. A plurality of wave-shaped channel grooves (recesses) 44a are formed on the surface 14b. The wave-shaped channel grooves 44a have a shape corresponding to the back side of the wave-shaped channel grooves 36a of the first fuel gas channel 36.

A first oxidant gas channel 50 is formed on a surface 18a of the second metal separator 18 that faces the second membrane electrode assembly 16a. The first oxidant gas channel 50 connects the oxidant gas inlet manifold 30a to the oxidant gas outlet manifold 30b. The first oxidant gas channel 50 includes a plurality of wave-shaped channel grooves (recesses) 50a that extend in the direction of arrow C. An inlet buffer portion 52 and an outlet buffer portion 54 are respectively disposed near the inlet and the outlet of the first oxidant gas channel 50.

A second fuel gas channel 58 is formed on a surface 18b of the second metal separator 18 that faces the second membrane electrode assembly 16b. The second fuel gas channel 58 connects the fuel gas inlet manifold 32a to the fuel gas outlet manifold 32b. The second fuel gas channel 58 includes a plurality of wave-shaped channel grooves (recesses) 58a that extend in the direction of arrow C. An inlet buffer portion 60 and an outlet buffer portion 62 are respectively disposed near the inlet and the outlet of the second fuel gas channel 58. The second fuel gas channel 58 has a shape corresponding to the back side of the first oxidant gas channel 50. The inlet buffer portion 60 and the outlet buffer portion 62 are formed on the back sides of the inlet buffer portion 52 and the outlet buffer portion 54 and have the shapes corresponding to the back sides, respectively.

A second oxidant gas channel 66 is formed on a surface 20a of the third metal separator 20 that faces the second membrane electrode assembly 16b. The second oxidant gas channel 66 connects the oxidant gas inlet manifold 30a to the oxidant gas outlet manifold 30b. The second oxidant gas channel 66 includes a plurality of wave-shaped channel grooves (recesses) 66a that extend in the direction of arrow C. An inlet buffer portion 68 and an outlet buffer portion 70 are respectively disposed near the inlet and the outlet of the second oxidant gas channel 66.

A part of the coolant channel 44 is formed on a surface 20b of the third metal separator 20. A plurality of wave-shaped channel grooves (recesses) 44b are formed on the surface 20b. The wave-shaped channel grooves 44b have a shape corresponding to the back side of the wave-shaped channel grooves 66a of the second oxidant gas channel 66.

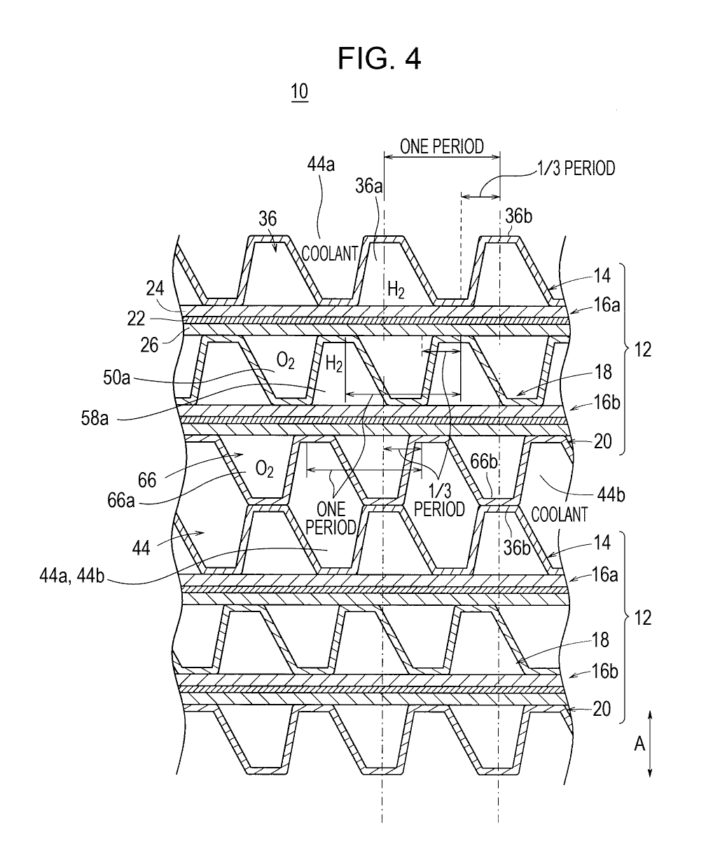

As illustrated in FIG. 4, the first metal separator (first-end corrugated separator) 14, which is disposed at a first end of the power generation unit 12 in the stacking direction, includes first flat portions (first protrusions) 36b that protrude between the wave-shaped channel grooves 44a of the coolant channel 44 in a direction away from the first membrane electrode assembly 16a. The first flat portions 36b are bottom portions of the wave-shaped channel grooves 36a of the first fuel gas channel 36.

The third metal separator (second-end corrugated separator) 20, which is disposed at a second end of the power generation unit 12 in the stacking direction, includes second flat portions (second protrusions) 66b that protrude between the wave-shaped channel grooves 44b of the coolant channel 44 in a direction away from the second membrane electrode assembly 16b. The second flat portions 66b are bottom portions of the wave-shaped channel grooves 66a of the second oxidant gas channel 66.

The first flat portions 36b and the second flat portions 66b are disposed so as to be superposed with each other in the stacking direction. To be specific, in the first metal separator 14, in one period between peak portions (the first flat portions 36b), which are the bottom portions of the first fuel gas channel 36, the distance between one of the peak portions and a bottom portion adjacent to the peak portion is set at ⅓ period.

In the second metal separator 18, in one period between peak portions, which are bottom portions of the second fuel gas channel 58, the distance between one of the peak portions and a bottom portion adjacent to the peak portion is set at ⅓ period. In the third metal separator 20, in one period between peak portions (the second flat portions 66b), which are the bottom portions of the second oxidant gas channel 66, the distance between one of the peak portions and a bottom portion adjacent to the peak portion is set at ⅓ period.

If the power generation unit 12 includes four MEAs and five corrugated separators, the distance between an peak portion and a bottom portion adjacent to the peak portion is set at ⅕ period. That is, if (n+1) corrugated separators are used, in each of the corrugated separators, the distance between an peak portion in a period of the wave-shaped channel grooves and a bottom portion adjacent to the peak portion is set at 1/(n+1) period.

As long as the first flat portions 36b and the second flat portions 66b are disposed so as to be superposed with each other in the stacking direction, the distance between an peak portion and a bottom portion adjacent to the peak portion need not be set at ⅓ period, ⅕ period, or the like.

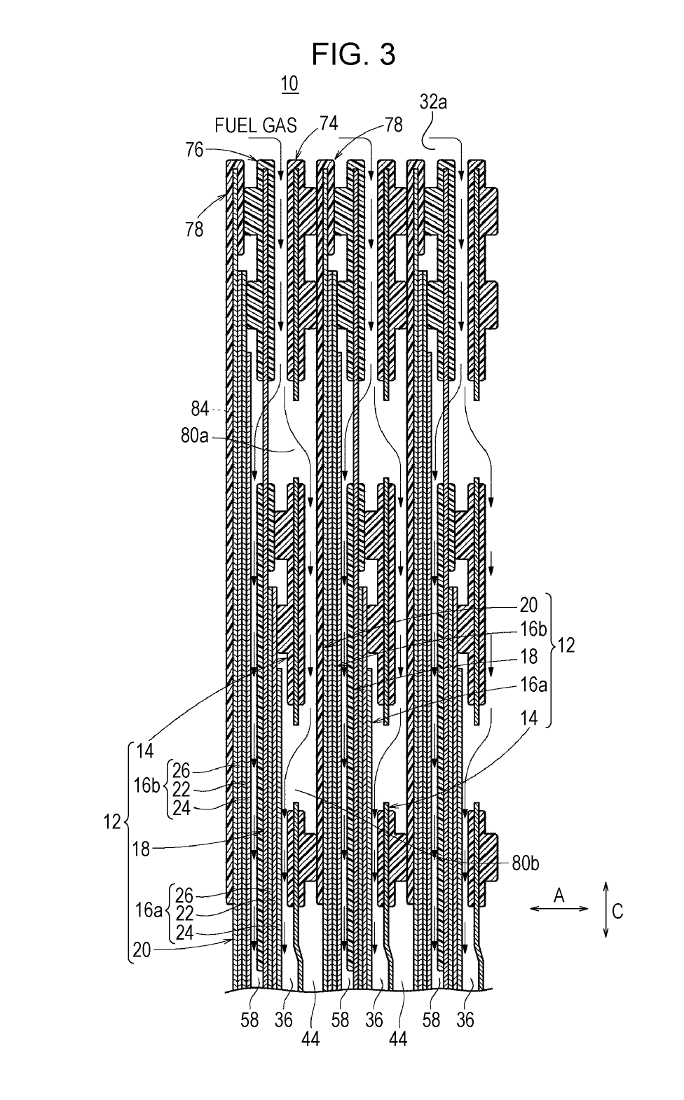

As illustrated in FIGS. 2 and 3, a first sealing member 74 is integrally formed on the surfaces 14a and 14b of the first metal separator 14 so as to surround the outer peripheral edge of the first metal separator 14. A second sealing member 76 is integrally formed on the surfaces 18a and 18b of the second metal separator 18 so as to surround the outer peripheral edge of the second metal separator 18. A third sealing member 78 is integrally formed on the surfaces 20a and 20b of the third metal separator 20 so as to surround the outer peripheral edge of the third metal separator 20.

The first metal separator 14 includes a plurality of outer inlets 80a and a plurality of inner inlets 80b that connect the fuel gas inlet manifold 32a to the first fuel gas channel 36 and a plurality of outer outlets 82a and a plurality of inner outlets 82b that connect the fuel gas outlet manifold 32b to the first fuel gas channel 36.

The second metal separator 18 includes a plurality of inlets 84 that connect the fuel gas inlet manifold 32a to the second fuel gas channel 58 and a plurality of outlets 86 that connect the fuel gas outlet manifold 32b to the second fuel gas channel 58.

When the power generation units 12 are stacked on top of each other, the coolant channel 44, which extends in the direction of arrow B, is formed between the first metal separator 14 of one of the power generation units 12 and the third metal separator 20 of another of the power generation units 12.

Hereinafter, the operation of the fuel cell stack 10 will be described.

As illustrated in FIG. 2, an oxidant gas, such as an oxygen-containing gas, is supplied to the oxidant gas inlet manifold 30a. A fuel gas, such as a hydrogen-containing gas, is supplied to the fuel gas inlet manifold 32a. A coolant, such as pure water, ethylene glycol, or oil, is supplied to the coolant inlet manifolds 34a.

The oxidant gas is introduced through the oxidant gas inlet manifold 30a to the first oxidant gas channel 50 of the second metal separator 18 and to the second oxidant gas channel 66 of the third metal separator 20. The oxidant gas flows through the first oxidant gas channel 50 in the direction of arrow C (the direction of gravity), and is supplied to the cathode electrode 26 of the first membrane electrode assembly 16a. Moreover, the oxidant gas flows through the second oxidant gas channel 66 in the direction of arrow C, and is supplied to the cathode electrode 26 of the second membrane electrode assembly 16b.

As illustrated in FIG. 3, the fuel gas flows from the fuel gas inlet manifold 32a through the outer inlets 80a to the surface 14b side of the first metal separator 14. Then, the fuel gas is introduced through the inner inlets 80b to the surface 14a side of the first metal separator 14, and flows to the inlet buffer portion 38. The fuel gas further flows through the first fuel gas channel 36 in the direction of gravity (direction of arrow C), and is supplied to the anode electrode 24 of the first membrane electrode assembly 16a (see FIG. 2).

Moreover, as illustrated in FIG. 3, the fuel gas flows through the inlets 84 to the surface 18b side of the second metal separator 18. Therefore, as illustrated in FIG. 2, the fuel gas is supplied to the inlet buffer portion 60 on the surface 18b side of the second metal separator 18, flows through the second fuel gas channel 58 in the direction of arrow C, and is supplied to the anode electrode 24 of the second membrane electrode assembly 16b.

The oxidant gas and the fuel gas, which are respectively supplied to the cathode electrode 26 and the anode electrode 24, cause electrochemical reactions in the electrode catalyst layers of the first and second membrane electrode assemblies 16a and 16b, thereby generating electric power.

Next, the oxidant gas, which has been supplied to the cathode electrodes 26 of the first and second membrane electrode assemblies 16a and 16b and has been consumed, is discharged through the oxidant gas outlet manifold 30b in the direction of arrow A.

The fuel gas, which has been supplied to the anode electrode 24 of the first membrane electrode assembly 16a and has been consumed, is discharged through the outlet buffer portion 40 and the inner outlets 82b to the surface 14b side of the first metal separator 14. The fuel gas, which has been discharged to the surface 14b side of the first metal separator 14, flows through the outer outlets 82a, returns to the surface 14a side of the first metal separator 14, and is discharged to the fuel gas outlet manifold 32b.

The fuel gas, which has been supplied to the anode electrode 24 of the second membrane electrode assembly 16b and has bee consumed, flows through the outlet buffer portion 62 and the outlets 86 to the surface 18a side of the second metal separator 18. Then, the fuel gas is discharged to the fuel gas outlet manifold 32b.

The coolant that has been supplied to the pair of coolant inlet manifolds 34a flows through the coolant channel 44, which is formed between the power generation units 12, in streams that flow in directions of arrow B so as to approach each other. Then, the streams of the coolant collide with each other in a middle part of the coolant channel 44 in the directions of arrow B, flow in the direction of gravity (downward in the direction of arrow C), and are discharged to the coolant outlet manifolds 34b, which are disposed in lower lateral side portions of the power generation unit 12.

In the present embodiment, as illustrated in FIG. 4, the first metal separator 14, which is disposed at one end of the power generation unit 12 in the stacking direction, includes the first flat portions 36b that protrude between the wave-shaped channel grooves 44a of the coolant channel 44 in a direction away from the first membrane electrode assembly 16a. Moreover, the third metal separator 20, which is disposed at the other end of the power generation unit 12 in the stacking direction, includes the second flat portions 66b that protrude between the wave-shaped channel grooves 44b of the coolant channel 44 in a direction away from the second membrane electrode assembly 16b. The first flat portions 36b and the second flat portions 66b are disposed so as to be superposed with each other in the stacking direction.

Therefore, when the power generation units 12 are stacked on top of each other, the first flat portions 36b of the first metal separator 14 of one of the power generation units 12 and the second flat portions 66b of the third metal separator 20 of another of the power generation units 12 are disposed so as to be superposed with each other in the stacking direction, and the coolant channel 44 is formed between these power generation units 12.

Therefore, the coolant channel 44 is formed between the power generation units 12 only by stacking the power generation units 12 on top of each other. Thus, the fuel cell stack 10 including the coolant channels 44 having a skip cooling structure can be easily manufactured. Therefore, the total number of components are reduced because the number of common components is increased, so that the fuel cell stack can be assembled with a high efficiency and at low cost.

In the present embodiment, the first fuel gas channel 36, the first oxidant gas channel 50, the second fuel gas channel 58, and the second oxidant gas channel 66 respectively include a plurality of the wave-shaped channel grooves 36a, 50a, 58a, and 66a. However, the present invention is not limited thereto. For example, the first fuel gas channel 36, the first oxidant gas channel 50, the second fuel gas channel 58, and the second oxidant gas channel 66 each may include a plurality of linear channel grooves.

With the embodiment of the present invention, when the power generation units are stacked on top of each other, the first flat portions of the first-end corrugated separator of one of the power generation units and the second flat portions of the second-end corrugated separator of another of the power generation units are disposed so as to be superposed with other in the stacking direction, and the coolant channel is formed between these power generation units.

Therefore, the coolant channel is formed between the power generation units only by stacking the plurality of power generation units on top of each other. Thus, a fuel cell stack including the coolant channel having a skip cooling structure can be easily manufactured. Therefore, the total number of components are reduced because the number of common components is increased, so that the fuel cell stack can be assembled with a high efficiency and at low cost.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell stack comprising:
a plurality of power generation devices each comprising:
n membrane electrode assemblies each including electrodes and an electrolyte that is sandwiched between the electrodes, n being an even number;
(n+1) corrugated separators that are alternately stacked together with the membrane electrode assemblies, the corrugated separators sandwiching both sides of the membrane electrode assemblies with third protrusions of the corrugated separators in a stacking direction; and
a reactant gas channel that allows a reactant gas to flow along an electrode surface in a plane direction of the corrugated separators, the reactant gas being one of a fuel gas and an oxidant gas; and
a coolant channel provided between the power generation devices,
wherein a first-end corrugated separator among the corrugated separators has a first protrusion that protrudes between recesses of the coolant channel in a direction away from one of adjacent membrane electrode assemblies of the membrane electrode assemblies, the first-end corrugated separator being disposed at a first end of each of the power generation devices in the stacking direction,
wherein a second-end corrugated separator among the corrugated separators has a second protrusion that protrudes between recesses of the coolant channel in a direction away from another of the adjacent membrane electrode assemblies, the second-end corrugated separator being disposed at a second end of each of the power generation devices in the stacking direction, and
wherein the first protrusion and the second protrusion are disposed so as to be superposed with each other in the stacking direction.

2. The fuel cell stack according to claim 1,
wherein the reactant gas channel includes a plurality of wave-shaped reactant gas channel grooves provided on each of the corrugated separators.

3. The fuel cell stack according to claim 1,
wherein the coolant channel is provided on a back side of the reactant gas channel and has a shape corresponding to the back side.

4. The fuel cell stack according to claim 1,
wherein the (n+1) corrugated separators are disposed such that a distance between an peak portion in a period of a wave-shaped channel groove and a bottom portion adjacent to the peak portion is set at 1/(n+1) period.

5. The fuel cell stack according to claim 2,
wherein the coolant channel is provided on a back side of the reactant gas channel and has a shape corresponding to the back side.

6. The fuel cell stack according to claim 2,
wherein the (n+1) corrugated separators are disposed such that a distance between an peak portion in a period of a wave-shaped channel groove and a bottom portion adjacent to the peak portion is set at 1/(n+1) period.

7. The fuel cell stack according to claim 3,
wherein the (n+1) corrugated separators are disposed such that a distance between an peak portion in a period of a wave-shaped channel groove and a bottom portion adjacent to the peak portion is set at 1/(n+1) period.

8. The fuel cell stack according to claim 5,
wherein the (n+1) corrugated separators are disposed such that a distance between an peak portion in a period of a wave-shaped channel groove and a bottom portion adjacent to the peak portion is set at 1/(n+1) period.
